(19) United States
(12) Patent Application Publication
(10) Pub. No.: US 2009/0059573 A1
(43) Pub. Date: Mar. 5, 2009

(54) SOLID-STATE LIGHTING DEVICE

(76) Inventors: James Bears, Boynton Beach, FL (US); Michael Romeo, Port St. Lucie, FL (US); Raymond Beja, Port Salerno, FL (US); Bryan J. Blazie, Stuart, FL (US); Chris Bradbrook, Palm Bay, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/846,812

(22) Filed: Aug. 29, 2007

(51) Int. Cl. F21L 4/00; F21V 7/00

(52) U.S. Cl. 362/183; 362/241

(57) ABSTRACT

A solid-state lighting device for illuminating a predetermined area having a width and length includes a reflector having at least one cavity. At least one edge emitting solid-state light-emitting device is positioned relative to the cavity of the reflector. The cavity includes an inner curved surface terminating at an edge proximate the solid-state light-emitting device. The inner curved surface has a curvature such that a light intensity of the device has a sharp drop-off in intensity at a boundary of the width and a slowly attenuating light at a boundary of the length.

### FIELD OF THE INVENTION

The invention relates to lighting devices and with more particularity to lighting devices having solid-state light-emitting members.

### BACKGROUND OF THE INVENTION

Solid-state light-emitting devices such as light-emitting diodes, electroluminescent devices and other solid-state devices provide a light source that has advantages over prior art devices such as incandescent or fluorescent bulbs. Solid-state lighting devices are generally more energy efficient and have a longer service life in comparison to incandescent and fluorescent devices. Additionally, costs associated with the production of lighting devices having solid-state light members are lower in comparison to prior art devices having fluorescent or incandescent type lights.

When lighting large areas for path lighting or road lighting purposes it is desirable to produce a light distribution having specific light characteristics such that a light is directed in a specific pattern to illuminate a predetermined area. Prior art solid-state illumination devices generally use a cluster of light-emitting devices disposed in a conventional lighting fixture. Such prior art devices do not accommodate or provide lighting characteristics desirable for path or road lighting purposes. Additionally, prior art lighting devices having light-emitting diodes may be housed in conventional lighting fixtures leading to overheating and shortening a service life of solid-state illumination devices.

There is therefore a need in the art for a solid-state lighting device providing a desired light pattern for use in path or road lighting applications. There is also a need in the art for a solid-state lighting device that is economical and provides for low power applications such as photovoltaic-powered applications, battery-powered applications and other off-grid applications.

### SUMMARY OF THE INVENTION

A solid-state lighting device for illuminating a predetermined area having a width and length includes a reflector having at least one cavity. At least one solid-state light-emitting device is positioned relative to the at least one cavity of the reflector. The at least one cavity includes an inner curved surface that terminates at an edge proximate the solid-state light-emitting device and extends to another edge defining a cut-off boundary. The inner curved surface has a curvature such that light distribution along the width of the predetermined area has a cut-off angle of from 10 to 75 degrees relative to a horizontal axis. Additionally, light distribution along the length of the predetermined area has a cut-off angle of from 0 to 40 degrees from the horizontal axis.

In another aspect, a solid-state lighting device for illuminating a predetermined area having a width and length includes a reflector having at least one cavity. At least one edge emitting solid-state light-emitting device is positioned relative to the at least one cavity of the reflector. The at least one cavity includes an inner curved surface terminating at an edge proximate the solid-state light-emitting device. The edge may be just below tie phosphor coating allowing reflection of light emitted sideways. The inner curved surface has a curvature such that a light intensity of the device has a sharp drop-off in intensity at a boundary of the width and a slowly attenuating light at a boundary of the length.

In another aspect, a solid-state lighting device for illuminating a predetermined area having a width and length includes a reflector having four cavities. At least one solid-state light-emitting device is positioned relative to one of the four cavities of the reflector. The number of solid-state light-emitting devices may be adjusted to accommodate various power consumption and lighting characteristics.

### BRIEF DESCRIPTION OF TEE DRAWINGS

FIG. 1 is a perspective view of a light pole including the solid-state lighting device and displaying a predetermined area to be lit;

FIG. 2 is a perspective view of a reflector of the solid-state lighting device;

FIG. 3 is a sectional view of the reflector and solid-state light-emitting device;

FIG. 4 is a sectional view of the reflector and solid-state light-emitting device;

FIG. 5 is a sectional view of the reflector and solid-state light-emitting device detailing a light distribution pattern arising from one of the light-emitting devices;

FIG. 6 is a sectional view of a reflector and solid-state light-emitting device detailing the light distribution arising from multiple light-emitting devices as an overlapping of the light distribution from the light-emitting devices;

FIG. 7 is a perspective view of a solid-state light-emitting device;

FIG. 8 is a top view of the dies positioned on the solid-state light-emitting device of FIG. 7;

FIG. 9 is a perspective view of a heat sink of the solid-state lighting device.

### DETAILED DESCRIPTION OF THE PREFERRED EMBODIMENTS

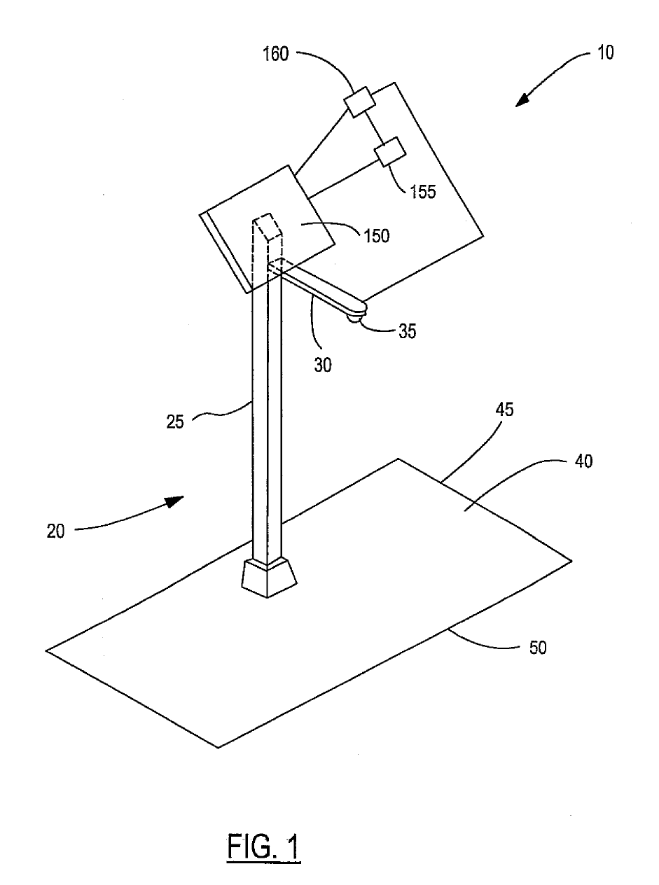

Referring to FIG. 1, there is shown a light 10 that may house a solid-state lighting device 15 according to one aspect. The light 10 may include a pole 20 having a vertical member 25 and a horizontal member 30 that has a housing 35 attached thereon. The housing 35 may receive the solid-state lighting device 15. The solid-state lighting device 15 positioned within the housing 35 illuminates a predetermined area 40 positioned under the housing 35 attached to the pole 20. The predetermined area 40 includes a width 45 and length 50.

The solid-state lighting device 15 includes a reflector 55 having at least one and alternatively a plurality of cavities 60. At least one solid-state light-emitting device 65 is positioned relative to the plurality of cavities 60 of the reflector 55. Each cavity 60 includes an inner curved surface 70 that terminates at an edge 75 proximate the solid-state light-emitting device 65 and extends to another edge 80 defining a cut-off boundary 85. The inner curved surface 70 has a curvature such that the light distribution along the width 45 of the predetermined area 40 may have a cut-off angle A of from 10 to 75 degrees measured relative to a horizontal axis, as shown in FIG. 3. The light distribution along the length 50 of the predetermined area 40 may have a cut-off angle B of from 0 to 40 degrees measured from the horizontal axis, as shown in FIG. 4. In this manner, the inner curved surface 70 has a curvature such that a light intensity of the device has a sharp drop-off in intensity at a boundary of the width 45 and a slowly attenuating light at a boundary of the length 50. This light distribution provides a desired light for path or road lighting such that a rectangular area receives a desired light intensity avoiding light pollution and gaps in lighting along a path or road. For a road application, lights may be positioned at specific intervals depending on the desired light intensity to provide a reliable source of light along a length of the road.

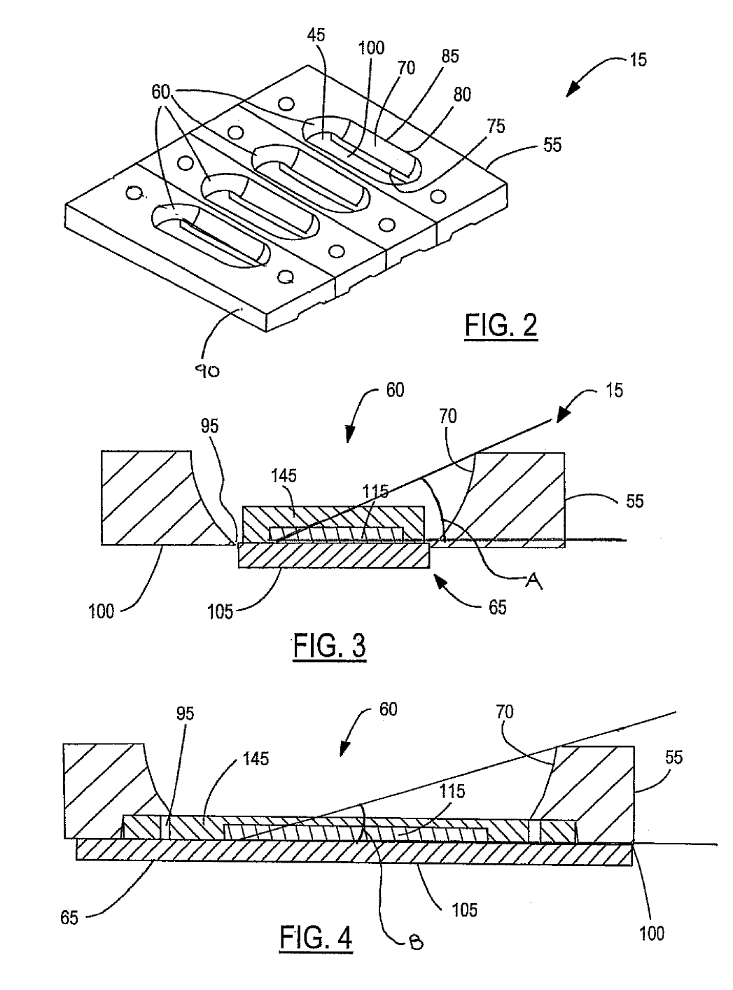

Referring to FIGS. 2, 3 and 4 there is shown a reflector 55 according to one aspect. The reflector 55 shown includes a base 90 having the plurality of cavities 60, with four cavities 60 being shown in the figure. Each cavity 60 includes a slot 95 formed in a bottom surface 100 of the cavity 60. The solid-state light-emitting device 65 is positioned from underneath the reflector 55 such that the solid-state light-emitting device 65 extends within the cavity 60 through the slot 95.

As stated above, the reflector 55 may include at least one and alternatively a plurality of cavities 60 with four cavities 60 being shown in the embodiment depicted in the figures. In one aspect, from one to four of the cavities 60 may include a solid-state light-emitting device 65 positioned relative to the cavities 60, as described above. In this manner, the number of solid-state light-emitting devices 65 may be adjusted to accommodate various power consumption and lighting characteristics.

The reflector 55 may be formed of a plastic material having a reflective material applied to the inner curved surface 70. The solid-state light-emitting device 65 may be mounted on a heat transferring element 105 of high thermal conductivity for dissipating heat generated by the solid-state light-emitting device 65 thereby extending a service life of such devices. In one aspect, the heat transferring element 105 may be a heat sink 110, as best shown in FIG. 9. In another aspect, the heat transferring element 105 may be a metal sheet or other heat conductive member. The heat sink 110 or other heat transferring element 105 may be associated with a housing 35 of the light 10 to allow heat to be dissipated through the housing 35.

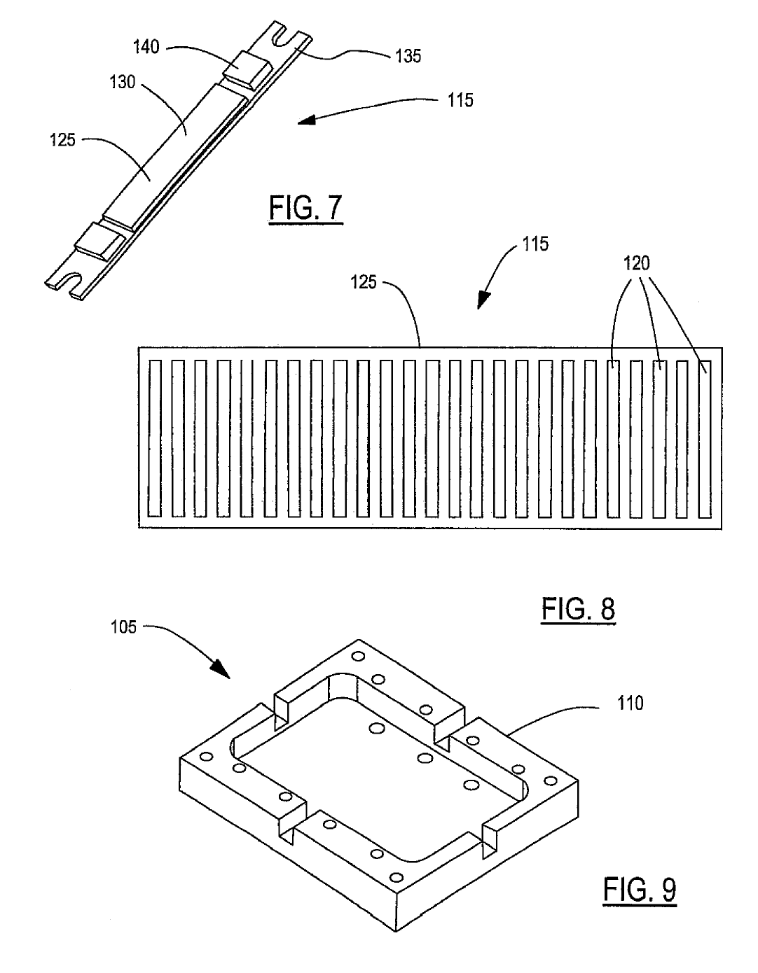

In one aspect and as shown in FIGS. 7 and 8, the solid-state light-emitting device 65 may be an edge emitting light-emitting diode 115. In one aspect, the edge emitting light-emitting diode 115 may include a plurality of rectangular dies 120 spaced from each other and arranged in a row forming an array 125. The array 125 may include a phosphor layer 130 disposed thereon with the array 125 attached to a metal substrate 135 having contacts 140. The array 125 may be positioned within the plurality of cavities 60 through the slot 95, as described above.

In one aspect, the solid-state light-emitting device 65 may include a cover 145 disposed thereon. The cover 145 may be formed of any appropriate material such as a glass or plastic silicone resin. The cover 145 may be utilized to protect the solid-state light-emitting device 65. Additionally, the cover 145 may include a lens for modifying a light distribution of the solid-state light-emitting device 65.

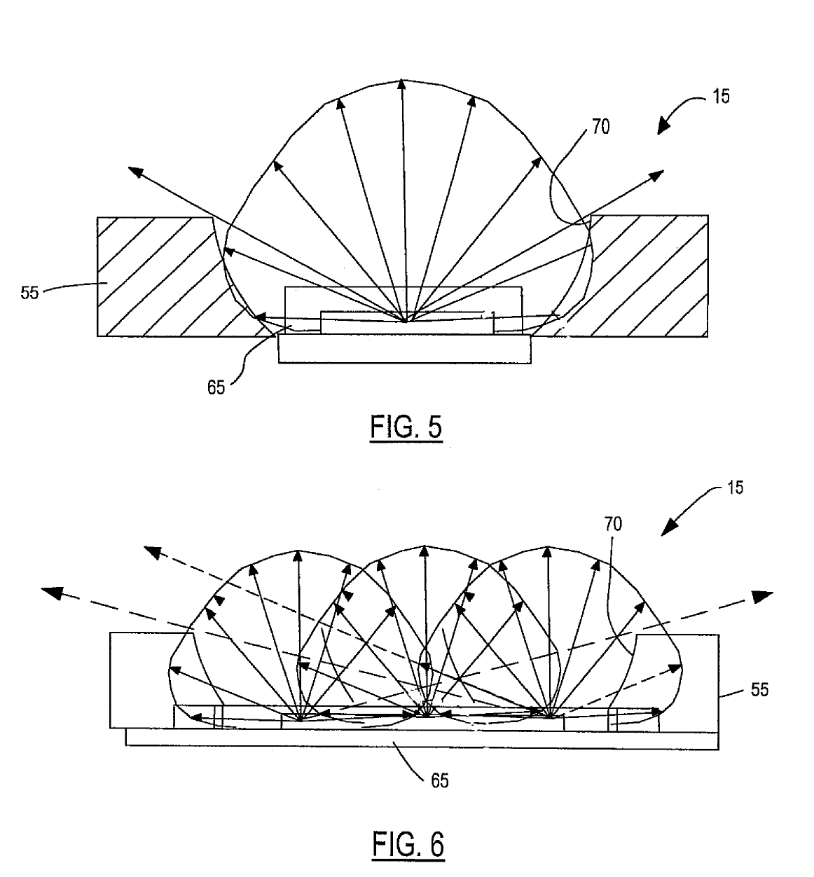

Referring to FIGS. 5 and 6, there is shown a light distribution represented by various vectors emitting light from the solid-state light-emitting device 65 to provide a desired lighting of the predetermined area 40. The section of FIG. 5 depicts a lighting distribution oriented along the width 45 of the predetermined area 40. As stated previously, the cut-off angle relative to a horizontal having a value of from 10 to 75 degrees provides a desired light configuration. In one embodiment, the depicted light distribution provides a desired lighting as described above covering a predetermined area 40 of approximately 25 feet in width. As stated above, the cutoff angle may be varied to accommodate various light distributions on different predetermined areas.

Referring to FIG. 6, the reflected light distribution is shown as oriented along the length 50 of the predetermined area 40. As can be seen in the figure, the long axis of the reflector 55 provides a lower cutoff angle than that of the previously described width. As previously stated, the cutoff angle along the length may be from 0 to 40 degrees measured from the horizontal axis. The depicted embodiment shown in FIG. 6 includes a light distribution from the light emitting devices 65 to achieve a desired rectangular lighting along a predetermined area 40 of approximately 60 to 100 feet in length. In one aspect, the solid-state lighting device 15 is operative to illuminate the predetermined area 40 with a level of illumination of at least 0.01 lumens per square foot.

In one aspect, the solid-state lighting device 15 may include a photovoltaic power source 150 associated with the solid-state light-emitting device 65. The photovoltaic power source 150 is operative to energize the solid-state light-emitting device 65. Additionally, a battery 155, shown schematically in FIG. 1 for storing photovoltaically generated power and providing power to the solid-state light-emitting device 65 may be included as well. A controller 160, shown schematically in FIG. 1 is in electrical communication with the battery 155 and the photovoltaic power source 150 may be operative to selectively deliver electrical power from the photovoltaic power source 150 to the battery 155 and from the battery 155 to the solid-state light-emitting device 65.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A solid-state lighting device for illuminating a predetermined area having a width and length, the solid-state lighting device comprising:
a reflector having at least one cavity;
at least one solid-state light-emitting device positioned relative to the at least one cavity of the reflector;
wherein the at least one cavity includes an inner curved surface terminating at an edge proximate the solid-state light-emitting device and extending to another edge defining a cut-off boundary, the inner curved surface having a curvature such that light distribution along the width of the predefined area has a cutoff angle of from 10 to 75 degrees relative to a horizontal axis and the light distribution along the length of the predetermined area has a cutoff angle of from 0 to 40 degrees relative to the horizontal axis.

2. The solid-state lighting device of claim 1 wherein the reflector includes a plurality of cavities.

3. The solid-state lighting device of claim 1 wherein the reflector includes four cavities.

4. The solid-state lighting device of claim 3 wherein from one to four of the cavities includes solid-state light-emitting devices positioned relative to the cavities.

5. The solid-state lighting device of claim 1 wherein the at least one cavity includes a slot formed in a bottom surface, the solid-state light-emitting device positioned within the slot.

6. The solid-state lighting device of claim 1 wherein the reflector is formed of a plastic material having a reflective material applied to the inner curved surface.

7. The solid-state lighting device of claim 1 wherein the solid-state light-emitting device is mounted on a heat transferring element of high thermal conductivity for dissipating heat generated by the solid-state light-emitting device.

8. The solid-state lighting device of claim 7 wherein the heat transferring element is a heat sink.

9. The solid-state lighting device of claim 7 wherein the heat transferring element is a metal sheet associated with a housing of the solid-state lighting device.

10. The solid-state lighting device of claim 1 wherein the solid-state light-emitting device comprises an edge emitting light-emitting diode.

11. The solid-state lighting device of claim 10 wherein the edge emitting light-emitting diode comprises a plurality of rectangular dies spaced from each other and arranged in a row forming an array.

12. The solid-state lighting device of claim 11 wherein the array includes a phosphor layer disposed thereon and the array attached to a metal substrate having contacts.

13. The solid-state lighting device of claim 12 wherein the array is positioned relative to the at least one cavity of the reflector.

14. The solid-state lighting device of claim 1, including a photovoltaic power source associated with the solid-state light-emitting device, the power source being operative to energize the solid-state light-emitting device.

15. The solid-state lighting device of claim 14 including a battery for storing photovoltaically generated power and providing power to the solid-state light-emitting device.

16. The solid-state lighting device of claim 15 including a controller in electrical communication with the battery and the photovoltaic power source, the controller being operative to selectively deliver electrical power from the photovoltaic power source to the battery, and from the battery to solid-state light-emitting device.

17. The solid-state lighting device of claim 1 further including a cover disposed on the solid-state light-emitting device.

18. The solid-state lighting device of claim 17 wherein the cover comprises a lens for modifying the light distribution of the solid-state light-emitting device.

19. The solid-state lighting device of claim 1, wherein the device is operative to illuminate the predetermined area with a level of illumination of at least 0.01 lumens per square foot.

20. The solid-state lighting device of claim 1 wherein the predetermined area is a rectangular area wherein a light intensity of the device has a sharp drop-off in intensity at a boundary of the width and a slowly attenuating light at a boundary of the length.

21. A solid-state lighting device for illuminating a predetermined area having a width and length, the solid-state lighting device comprising:
a reflector having at least one cavity;
at least one edge emitting solid-state light-emitting device positioned relative to the at least one cavity of the reflector;
wherein the at least one cavity includes an inner curved surface terminating at an edge proximate the solid-state light-emitting device, the inner curved surface having a curvature wherein a light intensity of the device has a sharp drop-off in intensity at a boundary of the width and a slowly attenuating light at a boundary of the length.

22. The solid-state lighting device of claim 21 wherein the reflector includes a plurality of cavities.

23. The solid-state lighting device of claim 21 wherein the edge is positioned below the phosphor coating allowing reflection of light emitted sideways.

24. A solid-state lighting device for illuminating a predetermined area having a width and length, the solid-state lighting device comprising:
a reflector having four cavities;
at least one solid-state light-emitting device positioned relative to one of the four cavities of the reflector;
wherein the number of solid-state light-emitting devices may be adjusted to accommodate various power consumption and lighting characteristics.
